(19) United States
(12) Patent Application Publication
(10) Pub. No.: US 2017/0032270 A1
(43) Pub. Date: Feb. 2, 2017

(54) METHOD FOR PREDICTING PERSONALITY TRAIT AND DEVICE THEREFOR

(71) Applicant: FOUNDATION OF SOONGSIL UNIVERSITY INDUSTRY COOPERATION, Seoul (KR)

(72) Inventors: Soo-Won LEE, Seoul (KR); Jong-Bum BAIK, Seoul (KR)

(73) Assignee: Foundation of Soongsil University Industry Cooperation

(21) Appl. No.: 15/118,096

(22) PCT Filed: May 29, 2014
(86) PCT No.: PCT/KR2014/004809

§ 371 Date: Oct. 17, 2016

(30) Foreign Application Priority Data
Feb. 11, 2014 (KR) 10-2014-0015212

(51) Int. Cl. G06N 7/00; H04L 29/08; G06F 19/00; G06N 5/02

(52) U.S. Cl. CPC G06N 7/005; G06N 5/02; H04L 67/22; G06F 19/3431

(57) ABSTRACT

A method of predicting personality traits using a personal life log and an apparatus for performing the same are disclosed. The method of predicting personality traits comprises collecting personal life log in a social network, generating a user behavior matrix by defining an object about user's behavior through analysis of the collected personal life log in a triple structure and extracting a user behavior parameter through the generated user behavior matrix, obtaining interaction between a user and a friend by analyzing the personal life log and obtaining a friend relation characteristic parameter by using the obtained interaction, obtaining a moving path characteristic parameter by using location information made in a feed by the user through analysis of the personal life log, and predicting personality traits by applying the user behavior parameter, the friend relation characteristic parameter and the moving path characteristic parameter to four learned personality traits models.

### TECHNICAL FIELD

The present disclosure relates to a method of predicting personality traits using a personal life log and an apparatus for performing the same.

### BACKGROUND ART

In smart industries, user experience UX is core factor determining success or failure of a smart device. According to an UX technology trend report of ETRI published in 2011, home and foreign outstanding companies such as a Google, an Apple, a Samsung, etc. give attention a personalization technique as a next generation technique for enhancing the UX. In reality, Google and Apple, which are both major companies, have provided personal secretary services which are called as Now™ and Siri™, respectively.

However, the conventional personalized services provide mostly only simple personalized information considering user's preference through a goods recommendation service, a personal secretary service and so on.

Additionally, the conventional personalized services build on a Big-5 Personality Traits Model widely used in psychology. The Big-5 Personality Traits Model is a general theory for describing personal character. However, the Big-5 Personality Traits Model has a limitation in that correlation between the Big-5 Personality Traits Model and user's purchase behavior is not verified.

Furthermore, the conventional personalized services use only very basic statistical value such as a number of friends, a number of clusters, a number of upload of photographs in an SNS such as a twitter, a facebook, etc. and thus they do not use various information concerning users' behaviors in the SNS.

### SUMMARY

Accordingly, the invention is provided to substantially obviate one or more problems due to limitations and disadvantages of the related art. One embodiment of the invention provides a method of predicting personality traits by using a personal life log and an apparatus for performing the same.

In addition, the invention provides a method of predicting personality traits for generating a new personality traits prediction model by using main personality traits used mainly in a consumer psychology theory through analysis of the personal life log and an apparatus for performing the same.

In one aspect, the invention provides a personality traits prediction method for predicting personality traits by analyzing a personal life log.

A method of predicting personality traits according to one embodiment of the invention comprises collecting personal life log in a social network; generating a user behavior matrix by defining an object about user's behavior through analysis of the collected personal life log in a triple structure and extracting a user behavior parameter through the generated user behavior matrix; obtaining interaction between a user and a friend by analyzing the personal life log and obtaining a friend relation characteristic parameter by using the obtained interaction; obtaining a moving path characteristic parameter by using location information made in a feed by the user through analysis of the personal life log; and predicting personality traits by applying the user behavior parameter, the friend relation characteristic parameter and the moving path characteristic parameter to four learned personality traits models.

In another aspect, the invention provides a personality traits prediction apparatus for predicting personality traits by analyzing a personal life log.

A personality traits prediction apparatus according to one embodiment of the invention comprises a collection unit configured to collect personal life log in a social network; a characteristic parameter extracting unit configured to generate a user behavior matrix by defining an object about user's behavior through analysis of the collected personal life log in a triple structure and extract a user behavior parameter through the generated user behavior matrix; a friend relation analyzing unit configured to obtain interaction between a user and a friend by analyzing the personal life log and obtain a friend relation characteristic parameter by using the obtained interaction; a moving path analyzing unit configured to obtain a moving path characteristic parameter by using location information made in a feed by the user through analysis of the personal life log; and a prediction unit configured to predict personality traits by applying the user behavior parameter, the friend relation characteristic parameter and the moving path characteristic parameter to four learned personality traits models.

The invention provides a method of predicting personality traits and an apparatus for performing the same, and so it may predict the personality traits by analyzing personal life log.

Moreover, the invention may generate a new personality traits prediction mode by using main personality traits used mainly in a consumer psychology theory through analysis of the personal life log.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a method of predicting personality traits according to one embodiment of the invention;

FIG. 2 is a view illustrating a user behavior matrix according to one embodiment of the invention;

FIG. 3 is a view illustrating division of two clusters using a K-average cluster algorithm according to one embodiment of the invention;

FIG. 4 to FIG. 7 are views illustrating example of optimal parameters of four personality traits prediction models according to one embodiment of the invention;

FIG. 8 is a view illustrating parameter distribution before normalization and parameter distribution after the normalization according to one embodiment of the invention;

FIG. 9 is a block diagram illustrating schematically a personality traits prediction apparatus according to one embodiment of the invention; and

FIG. 10 is a view illustrating a graph showing correlation increase degree based on prediction of the personality traits according to the conventional technique and one embodiment of the present invention.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

Hereinafter, various embodiments of the invention will be described in detail with reference to accompanying drawings.

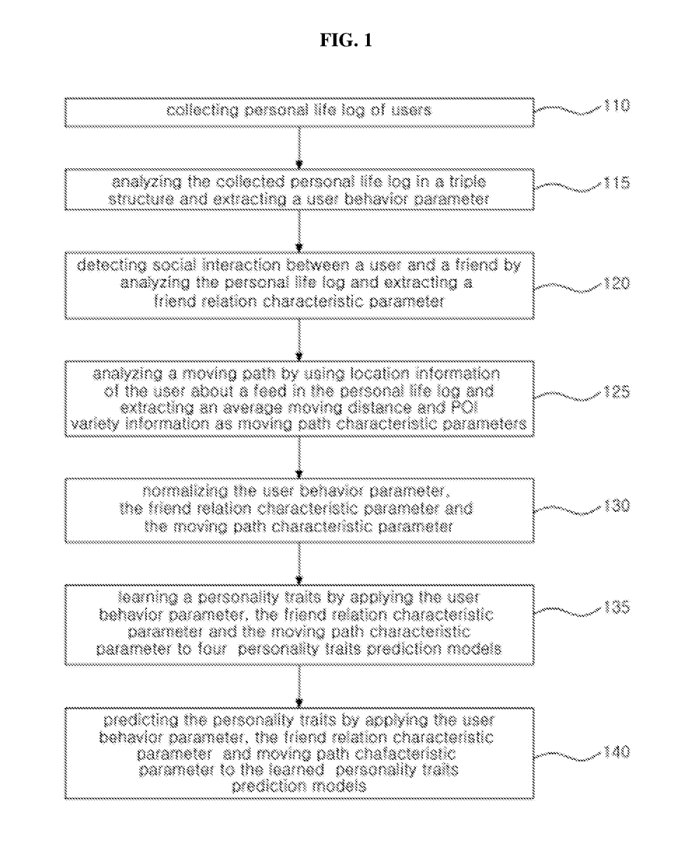

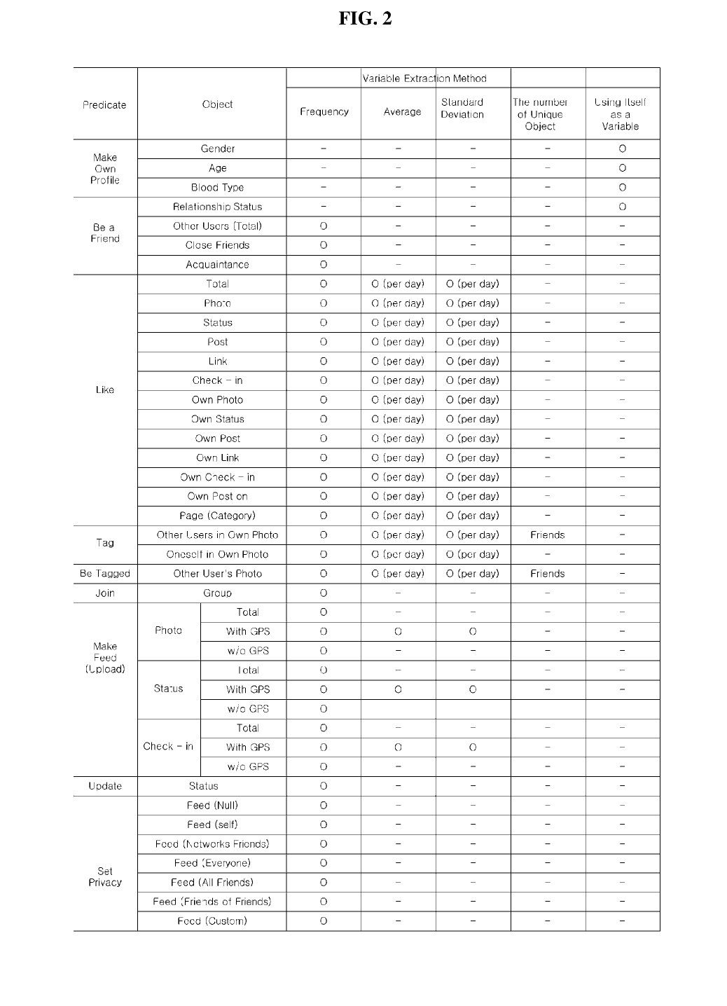

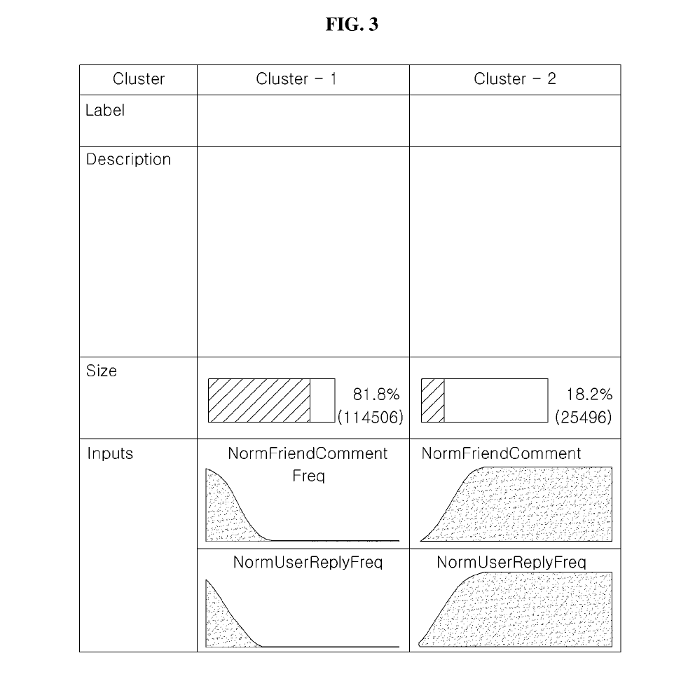

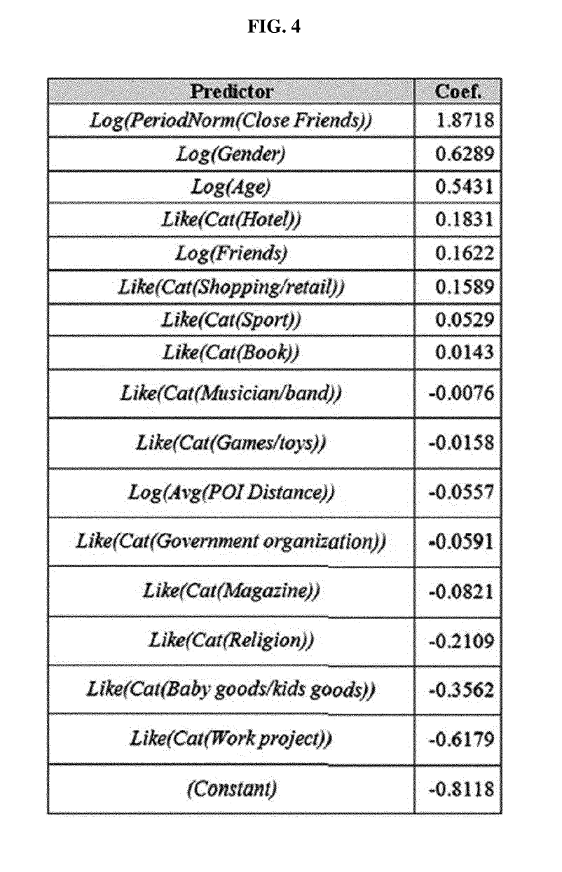

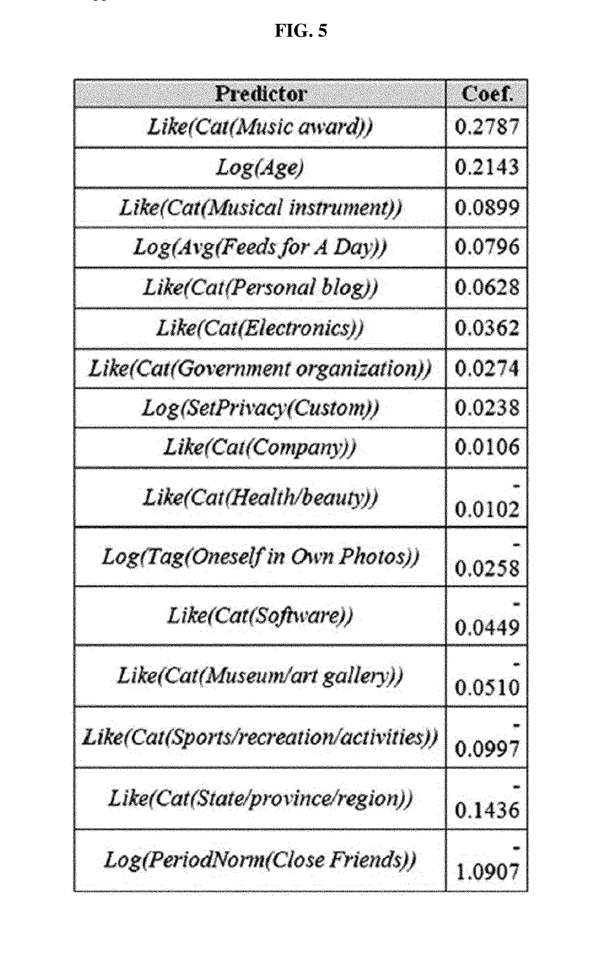

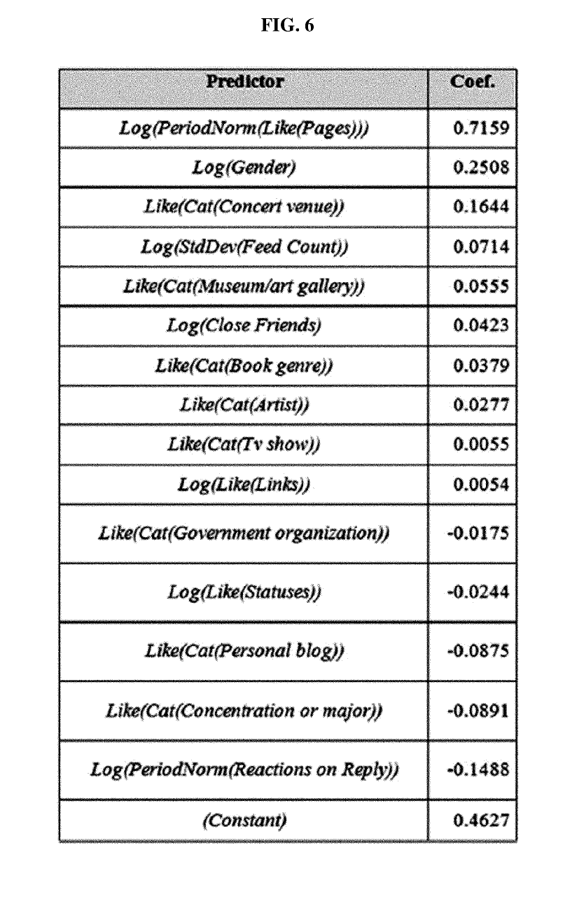

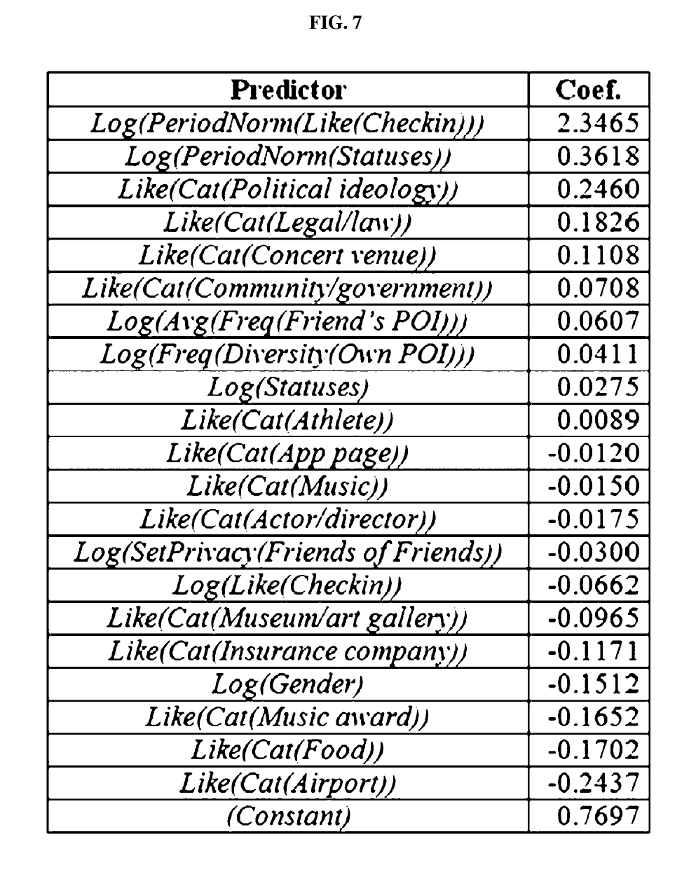

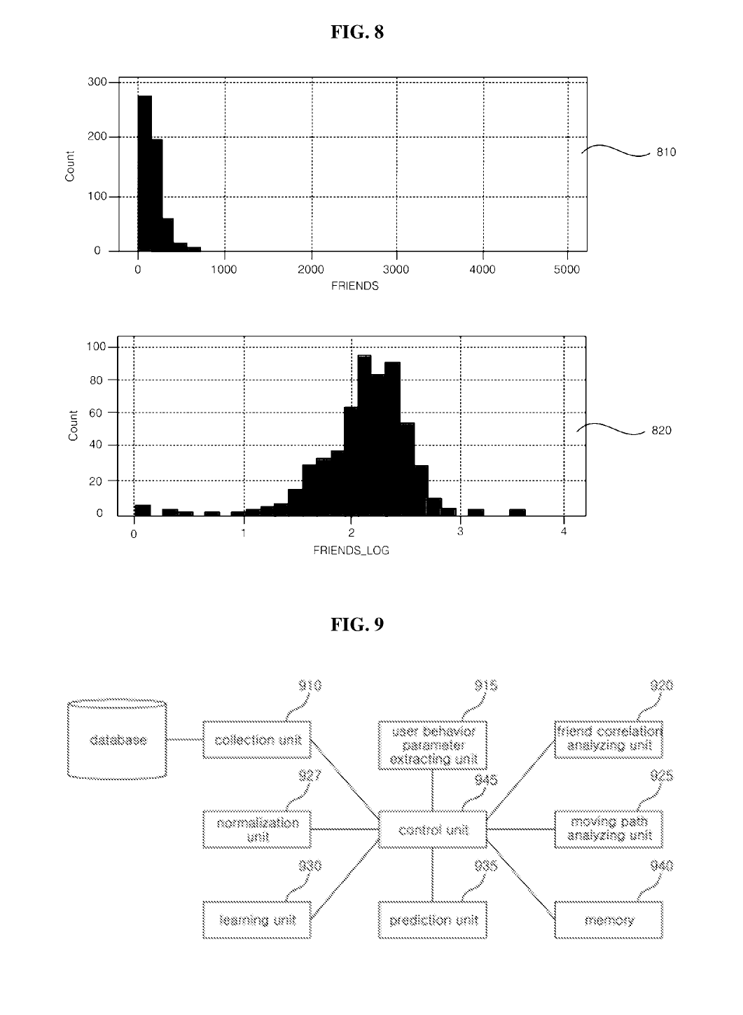

FIG. 1 is a flowchart illustrating a method of predicting personality traits according to one embodiment of the invention, FIG. 2 is a view illustrating a user behavior matrix according to one embodiment of the invention, and FIG. 3 is a view illustrating division of two clusters using a K-average cluster algorithm according to one embodiment of the invention. FIG. 4 to FIG. 7 are views illustrating example of optimal parameters of four personality traits prediction models according to one embodiment of the invention, and FIG. 8 is a view illustrating parameter distribution before normalization and parameter distribution after the normalization according to one embodiment of the invention.

In a step of 110, a personality traits prediction apparatus 100 obtains a survey about personality traits and an access token through a developed application (for example, online survey application), and then collects a personal life log of each of users through the access token.

The application for obtaining the survey about the personality traits and collecting the personal life log may be individually installed in advance to a user terminal.

In a step of 115, the personality traits prediction apparatus 100 analyzes the collected personal life log in a triple structure, and generates a user behavior parameter matrix by generalizing and defining objects about each of user's behaviors in a class level according to the analyzing. Subsequently, the personality traits prediction apparatus 100 extracts a user behavior parameter, which is a basic behavior parameter for defining the user's behavior, from the user behavior parameter matrix.

For example, the triple structure includes “user (subject)”, “object (object)” and “behavior (predicate)”. Hence, the personality traits prediction apparatus 100 may analyze the collected personal life log in the triple structure, and generate the user behavior parameter matrix by generalizing various user's behaviors in the class level (e.g. ‘User’ likes ‘Photo’) generalized from an instance level (e.g. ‘User1’ likes ‘Photo 1’), according to the analyzing.

FIG. 2 shows the user behavior parameter matrix.

As shown in FIG. 2, the personality traits prediction apparatus 100 may generate various user behavior parameter matrixes based on user's behavior about any object.

In the event that the user behavior parameter is extracted in a unit of individual pages when status of respective pages in a social network is expressed, a scarcity problem that a characteristic parameter value of a sample has 0 occurs.

Accordingly, the personality traits prediction apparatus 100 may generalize the user's behaviors based on a category in which the page is included, and extract the characteristic parameter for expressing the status depending on the category.

For example, it is assumed that the social network is a facebook. The personality traits prediction apparatus 100 may summarize 8355 pages in the facebook to approximately 183 categories by generalizing the 8355 pages, and determine status expression (e.g. good information) in respective categories as the characteristic parameter.

As described above, the personality traits prediction apparatus 100 may generate the user behavior parameter matrix organizing correlation in the SNS by analyzing the collected personal life log in the triple structure, and extract at least one user behavior parameter from the generated user behavior parameter matrix.

In a step of 120, the personality traits prediction apparatus 100 may detect social interaction between the user and the friend by analyzing the personal life log and extract the friend relation characteristic parameter based on the social interaction.

Here, the analysis of the social interaction may detect a frequency of comments written in a user's feed by a friend and a frequency of user's response about the comment written by the friend, and extract ‘a number of a close friend’ and ‘a number of acquaintance’ as the friend relation characteristic parameter by applying the detected frequencies to a K-average cluster algorithm.

In this case, the personality traits prediction apparatus 100 may detect the frequency of the comments written in the user's feed by the friend by accumulating a frequency of the comments written in the user's feed by the friend.

This is expressed as following equation 1.

$$FriendCommentFreq ( u , {f}_{u , i} ) = {\sum }_{j}^{\vert {Feed}_{u} \vert} CommentFreq ( {f}_{u , i} , {feed}_{u , j} ) \qquad [ Equation 1 ]$$

Here, u means the user, f_{u,i} indicates the user's friend, and feedᵤ means the user's feed. CommentFreq(f_{u,i},feed_{u,j}) indicates the frequency of the comments written in the user's feed by the friend.

In this case, the personality traits prediction apparatus 100 may normalize corresponding parameter in the range of 0 to 1, by dividing the frequency (FriendCommentFreq(u,f_{u,i})) of the comments written in the user's feed by the user's friend by the frequency of comments written in the user's feed by a friend who writes most number of comments in the user's feed, using equation 1. This is expressed as following equation 2.

$$NormFriendCommentFreq ( u , {f}_{u , i} ) = \frac{FriendCommentFreq ( u , {f}_{u , k} )}{{max}_{k} ( FriendCommentFreq ( u , {f}_{u , k} )} \qquad [ Equation 2 ]$$

The personality traits prediction apparatus 100 may determine the frequency of the user's response about the friend's comment by accumulating a frequency of the user's response written in a feed, in which the friend writes the comment, of a cluster including user's feeds. This is shown in following equation 3.

$$UserReplyFreq ( u , {f}_{u , i} ) = {\sum }_{j}^{\vert {Feed}_{u} \vert} ReplyFreq ( {f}_{u , i} , {feed}_{u , j} ) \qquad [ Equation 3 ]$$

Here, u means the user, feedᵤ indicates the cluster including feeds written by the user (u), and f_{u,i} means the user's friend. feed_{u,j} indicates the feed in which the comment is written by the user's friend, and ReplyFreq(f_{u,i},feed_{u,j}) means the frequency of user's response in the feed where the user's friend writes the comment. The frequency of the user's response may be generated by accumulating the frequency of the user's response in the feed in which the user's friend writes the comment.

Subsequently, the personality traits prediction apparatus 100 may normalize corresponding parameter in the range of 0 to 1, by dividing the frequency of the user's response about the friend's comment by a frequency of the user's response about a comment written by a friend who writes most number of comments.

This is expressed as following equation 4.

$$NormUserReplyFreq ( u , {f}_{u , i} ) = \frac{UserReplyFreq ( u , {f}_{u , i} )}{{max}_{k} ( UserReplyFreq ( u , {f}_{u , I} ) )} \qquad [ Equation 4 ]$$

The personality traits prediction apparatus 100 may obtain the frequency of the comment written in the feed by the friend and the frequency of the user's response about the comment, and divide friends into a close friend and a friend not the close friend by clustering the friends by applying the obtained frequencies to the K-average cluster algorithm.

FIG. 3 illustrates division of two clusters using the K-average cluster algorithm. As shown in FIG. 3, it is verified that friends in a friend list is divided into the close friend and acquaintance in a ratio of approximately 8:2. In FIG. 3, a first cluster corresponds to the acquaintance, and a second cluster corresponds to the close friend.

The personality traits prediction apparatus 100 may extract a number of the close friend and a number of the acquaintance divided by using the K-average cluster algorithm as the characteristic parameters, respectively.

In a step of 125, the personality traits prediction apparatus 100 analyzes a moving path by using location information of the user made in the feed through the personal life log, and extracts an average moving distance and POI variety information as moving path characteristic parameters, respectively.

Here, the location information may be at least one of a GPS coordinate, a name of a specific place or an identification information ID of the specific place.

For example, the personality traits prediction apparatus 100 may obtain the moving path characteristic parameter by using the GPS information made in the feed by the user, to analyze a difference of the moving path depending on user's propensity.

Generally, analyzing the moving path of the user may give important meaning when the user's propensity, e.g. extroversion is to be predicted. Generally, extroverts get around actively multiple points of interest POIs, and introvert persons have a limited moving path around a specific POI.

Accordingly, the personality traits prediction apparatus 100 may extract an average moving path and the POI variety information as characteristic parameters by analyzing GPS information made in the feed by the user, to model difference between the moving paths according to propensities of the users. Here, the PIO variety information includes a number of visiting places per the user and an average visiting number of the same place per the user.

In one embodiment, the average moving distance indicates a reference for determining radius of action of the user by using a distance between the POIs made in the feed by the user.

Accordingly, the personality traits prediction apparatus 100 may obtain the average moving distance by calculating Euclidian distance using a GPS coordinate.

Every value of a Euclidian distance matrix is symmetric, and every value of a diagonal matrix has 0. As a result, the personality traits prediction apparatus 100 may obtain the average moving distance by calculating an average of distances corresponding to a half the value in the Euclidian distance matrix except values arranged in a diagonal direction. This is shown in following equation 5.

$$AveragePOIDistance ( u ) = \frac{\begin{matrix}{\sum }_{m = 1}^{\vert {L}_{u} \vert} {\sum }_{n = m + 1}^{\vert {L}_{u} \vert} \\ \sqrt{{( {Lat}_{u , m} - {Lat}_{u , n} )}^{2} + {( {Long}_{u , m} - {Long}_{u , m} )}^{2}}\end{matrix}}{( {\vert {L}_{u} \vert}^{2} - \vert {L}_{u} \vert ) / 2} \qquad [ Equation 5 ]$$

Here, u means the user, Lᵤ indicates the location information made by the user, and the location information (Lᵤ) may be expressed with a cluster including latitude and longitude as shown in following equation 6.

Lᵤ={(Lat_{u,1},Long_{u,1}),(Lat_{u,2},Long_{u,2}), . . . ,(Lat_{u,n},Long_{u,n})} [Equation 6]

In one embodiment, the POI variety information is a reference for determining distribution and frequency of the visiting places made in the feed by the user, and indicates how many the user actively goes around various places.

The location information of the user may include a name of a specific place such as place identification information (for example, a place ID and a place name), etc. as well as the GPS coordinate.

Of course, in the event that the user does not record information about the specific place, corresponding data does not exist.

The personality traits prediction apparatus 100 may model the POI variety by obtaining the number of the visiting place per the user and the average visiting number of the same place per the user using the location information of the user.

In a step of 130, the personality traits prediction apparatus 100 normalizes the user behavior parameter, the friend relation characteristic parameter and the moving path characteristic parameter, respectively.

Referring to numeric distribution of the extracted characteristic parameters, most values are biased in a left direction due to some active users (heavy user), as shown in 810 in FIG. 8. Generally, a linear model is very sensitive to distribution of a parameter value. Accordingly, the personality traits prediction apparatus 100 performs in advance a process of normalizing the parameters by applying a log function to each of the parameters, to maintain distribution of each of the parameter values with similar level. However, since a log value of 0 does not exist, the personality traits prediction apparatus 100 normalizes the parameters by applying the log function after adding 1. The distribution of the parameters in accordance with the normalization is shown in 820 in FIG. 8.

A problem exists in that characteristic parameters corresponding to the frequency of the extracted characteristic parameters are not fairly compared because a use period of an SNS by the users differs. Accordingly, the personality traits prediction apparatus 100 extracts a total use period per the user, and normalizes the characteristic parameters by dividing the characteristic parameter corresponding to the frequency by the total use period, so that the characteristic parameters have the same condition.

In one embodiment, the total use period per the user is extracted by using a number of days between a final feed generation day and an initial feed generation day.

The personality traits prediction apparatus 100 normalizes the parameters depending on a characteristic parameter normalization rule, because a distorted distribution or a characteristic parameter not interpreted semantically can be derived when the parameters are normalized in a lump by using a numerical value of the characteristic parameter and the total use period per the user. The characteristic parameter normalization rule is follows:

First rule: use date and correlation about characteristic parameters in a parameter list are calculated, characteristic parameters of which correlation is more than a critical value (for example, 0.2) are divided by the total use period per the user, and normalized parameter is added in a characteristic parameter list.

In this case, the characteristic parameter before the normalization is removed from the characteristic parameter list.

For example, the critical value may be set to have 0.2. This is because the correlation is generally determined based on 0.2 in a preceding research.

Second rule: skewness of every parameter in the characteristic parameter list is calculated, and then a log function is applied to a characteristic parameter of which skewness is more than 0. The characteristic parameter to which the log function is applied is added in the characteristic parameter list, and a characteristic parameter before the log function is applied is removed in the characteristic parameter list. A characteristic parameter of which normalization corresponding to the use date is applied is kept in the characteristic parameter list.

In the second rule, the use date and the characteristic parameter about which the normalization is performed by using the log function are used. This is because users whose use date is long may have a disadvantage in some characteristic parameters because a value of a specific behavior parameter does not absolutely increase in proportion to the user date. For example, there is a high possibility to slowdown an increase trend as a time elapses in case of a number of the close friends. Accordingly, a parameter cluster may be formed to perform mutual supplementation in consideration of the characteristic parameter to which the use date is applied according to the second rule and a characteristic parameter to which the use date is not applied.

In a step of 135, the personality traits prediction apparatus 100 learns personality traits by applying the user behavior parameter, the friend relation characteristic parameter and the moving path characteristic parameter to four personality traits prediction models. Here, the four personality traits prediction models include an extroversion prediction model, a public self consciousness prediction model, a prediction model of desire for uniqueness and a self esteem prediction model. The four personality traits prediction models are well-known in a customer psychology field, any further description concerning the models will be omitted.

More particularly, the personality traits prediction apparatus 100 obtains an optimal parameter combination for minimizing an average RMSE value of 10-fold cross validation from the user behavior parameter, the friend relation characteristic parameter and the moving path characteristic parameter by performing a wrapper subset evaluation through a greedy stepwise.

The optimal parameter combinations about the four personality traits prediction models are shown in FIG. 4 to FIG. 7, respectively.

FIG. 4 to FIG. 7 show an example of predicators and coefficients used for predicting the personality traits obtained about each of the four personality traits prediction models.

In FIG. 4 to FIG. 7, Log(•) means the fact that a log function is applied to an original value, and PeriodNorm(•) indicates the fact that date normalization is performed to the original value. SetPrivacy(•) means a predicator extracted from a disclosure level setting of the personal feed, and Cat(•) indicates a category label to which a page on which the user clicks “good” belongs. Friend's POI means a case that the user is tagged to a feed made by respective friends, and OwnPOI indicates a case that the user self-tags directly the location information.

The personality traits prediction apparatus 100 may learn respectively the personality traits prediction models by using the optimal parameter combinations obtained about each of the four personality traits prediction models, without using an attribute selection measure (a basic value: M5 method) of a linear regression algorithm.

The learning of the four personality traits prediction models is performed in advance through the steps 110 to 135, and then the steps 110 to 130 are performed. In a step of 140, the personality traits prediction apparatus 100 predicts the personality traits by applying the user behavior parameter, the friend relation characteristic parameter and the moving path characteristic parameter to the four learned personality traits prediction models.

For example, the personality traits prediction apparatus 100 may predict the personal propensities about each of the four personality traits prediction models by multiplying the predicator of an optimal parameter by the coefficient, by using the optimal parameter obtained from the four learned personality traits prediction models.

FIG. 9 is a block diagram illustrating schematically a personality traits prediction apparatus according to one embodiment of the invention.

In FIG. 9, the personality traits prediction apparatus 100 of the present embodiment includes a collection unit 910, a user behavior parameter extracting unit 915, a friend relation analyzing unit 920, a moving path analyzing unit 925, a normalization unit 927, a learning unit 930, a prediction unit 935, a memory 940 and a control unit 945.

The collection unit 910 obtains the survey about the personality traits and the access token through a preinstalled application (for example, online survey application), and then collects the personal life log of respective users through the access token. The collection unit 910 may store the collected personal life log in a database. The application may be installed to a user terminal and operates on the user terminal.

The user behavior parameter extracting unit 915 generates the user behavior parameter matrix by generalizing an object related to user's behavior by analyzing the collected personal life log in the triple structure, and extracts the user behavior parameter as the characteristic parameter through the generated user behavior parameter matrix.

The friend relation analyzing unit 920 obtains the friend relation characteristic parameter by using a level of closeness between the user and the friend obtained by analyzing social interaction between the user and the friend in the personal life log.

For example, the friend relation analyzing unit 920 may obtain the level of closeness between the user and the friend by using a frequency of comment written in the user's feed by the friend and a frequency of user's response about the comment, as the interaction between the user and the friend.

That is, the friend relation analyzing unit 920 may obtain a number of the close friend and a number of the acquaintance as the friend relation characteristic parameters by applying the frequency of the comment written in the user's feed by the friend and the frequency of the user's response about the comment to the K-average cluster algorithm.

The moving path analyzing unit 925 extracts the average moving distance and the POI variety as the characteristic parameters by analyzing GPS information made in the feed by the user, to model the difference of the moving path depending on the user's propensity.

The normalization unit 927 normalizes the user behavior parameter, the friend relation characteristic parameter and the moving path characteristic parameter according to the normalization rule.

The learning unit 930 learns the parameters by applying the user behavior parameter, the friend relation characteristic parameter and the moving path characteristic parameter to the four personality traits prediction models.

The user behavior parameter, the friend relation characteristic parameter and the moving path characteristic parameter may be normalized before the learning unit 930 learns the four personality traits prediction models. This is described in FIG. 1, and thus corresponding description will be omitted.

The prediction unit 935 predicts the personality traits by applying the user behavior parameter, the friend relation characteristic parameter and the moving path characteristic parameter to the four learned personality traits prediction models.

The memory 940 stores various algorithms needed for operation the personality traits prediction apparatus 100 and a variety of data derived in the process of predicting the personality traits.

The control unit 945 controls internal elements of the personality traits prediction apparatus 100, e.g. the collection unit 910, the user behavior parameter extracting unit 915, the friend relation analyzing unit 920, the moving path analyzing unit 925, the normalization unit 927, the learning unit 930, the prediction unit 935 and the memory 940, etc.

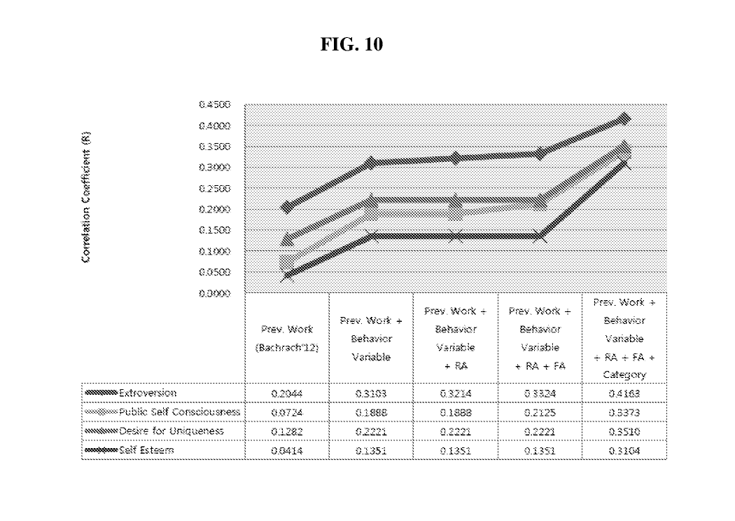

FIG. 10 is a view illustrating a graph showing correlation increase degree based on prediction of the personality traits according to the conventional technique and one embodiment of the present invention.

As mentioned above, the personality traits prediction model is learned by using the linear regression algorithm. R(Correlation Coefficient), R2(Coefficient of Determination) and RMSE (Root Mean Squared Error) are measured by using equation 7 to equation 9 through 10-fold cross validation, to evaluate prediction performance of the learned personality traits prediction models.

$$R = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - X )}^{2}} \sqrt{{\sum }_{i = 1}^{n} {( {Y}_{i} - Y )}^{2}}} \qquad [ Equation 7 ]$$

Here, Xᵢ means ith user's real personality traits value, and Yᵢ indicates ith user's personality traits value predicted by using the learned personality traits prediction model. X̅ and Y̅ mean an average of the real personality traits value and an average of the predicted personality traits value, respectively.

$$\begin{matrix}{R}^{2} = 1 - \frac{{\sum }_{i = 1}^{n} {( {X}_{i} - {Y}_{i} )}^{2}}{{\sum }_{i = 1}^{n} {( {X}_{i} - \overline{X} )}^{2}} & [ Equation 8 ] \\ RMSE = \sqrt{\frac{{\sum }_{i = 1}^{n} {( {X}_{i} - {Y}_{i} )}^{2}}{n}} & [ Equation 9 ]\end{matrix}$$

As shown in FIG. 10, it is verified that the present embodiment has enhanced performance by the extroversion of 0.21 and the self esteem of 0.26 in an R (correlation coefficient) compared with the conventional technique, in the event that the user behavior parameter and category information are added for the four personal propensities.

It is verified that analysis of the moving path and the friend relation affects considerably to predict the extroversion and the public self consciousness, but affects little to predict the desire for uniqueness and the self esteem.

On the other hand, the method of predicting the personality traits by analyzing the personal life log according to embodiment of the invention can be implemented in the form of program instructions that may be performed using various computer means and can be recorded in a computer-readable medium. Such a computer-readable medium can include program instructions, data files, data structures, etc., alone or in combination.

Examples of the program of instructions may include not only machine language codes produced by a compiler but also high-level language codes that can be executed by a computer through the use of an interpreter, etc.

The hardware mentioned above can be made to operate as one or more software modules that perform the actions of the embodiments of the invention, and vice versa.

The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

1. A method of predicting personality traits, the method comprising:
collecting personal life log in a social network;
generating a user behavior matrix by defining an object about user's behavior through analysis of the collected personal life log in a triple structure and extracting a user behavior parameter through the generated user behavior matrix;
obtaining interaction between a user and a friend by analyzing the personal life log and obtaining a friend relation characteristic parameter by using the obtained interaction;
obtaining a moving path characteristic parameter by using location information made in a feed by the user through analysis of the personal life log; and
predicting personality traits by applying the user behavior parameter, the friend relation characteristic parameter and the moving path characteristic parameter to four learned personality traits models.

2. The method of claim 1, wherein the user behavior matrix is defined by generalizing the behavior (predicate) of the user (subject) in the personal life log to the object (object),
and wherein the triple structure includes the user, the object and the behavior.

3. The method of claim 1, wherein the step of obtaining the friend relation characteristic parameter includes:
extracting a frequency of comment written in a user's feed by the friend and a frequency of user's response about the comment as the interaction, by analyzing the personal life log; and
extracting a number of a close friend and a number of acquaintance as the friend relation characteristic parameter by dividing clusters by applying the obtained interaction to a K-average cluster algorithm.

4. The method of claim 1, wherein the step of the moving path characteristic parameter comprising:
obtaining an average moving distance between visiting places by using the location information made by the user; and
extracting a number of the visiting places and a visiting frequency of the visiting places as the POI variety by using the location information.

5. The method of claim 1, wherein the average moving distance and the POI variety are determined as the moving path characteristic parameter, and
the location information includes at least one of a GPS coordinate, names of the visiting places or identification information (ID) of the visiting places.

6. The method of claim 1, wherein the step of predicting the personality traits includes:
obtaining optimal parameter combinations about each of the four personality traits prediction models by using the user behavior parameter, the friend relation characteristic parameter and the moving path characteristic parameter; and
performing a linear regression analysis by applying the obtained optimal parameter combinations to the four personality traits prediction models and predicting the personality traits through the linear regression analysis.

7. The method of claim 6, wherein the step of obtaining the optimal parameter combinations includes:
obtaining the optimal parameter combinations for minimizing a root mean square error RMSE of 10-fold cross validation by using the user behavior parameter, the friend relation characteristic parameter and the moving path characteristic parameter applied to the four personality traits prediction models.

8. The method of claim 1, wherein the four personality traits prediction models include an extraversion prediction model in a consumer psychology field, a public self consciousness prediction model, a prediction model of desire for uniqueness and a self esteem prediction model.

9. The method of claim 1, further comprising:
obtaining correlation between the user behavior parameter, the friend relation characteristic parameter and the moving path characteristic parameter and use date, and normalizing parameters by dividing the parameters of which the correlation is more than a first critical value by a total use period per the user; and
calculating skewness of the parameters and normalizing parameters by applying a log function to the parameters of which the skewness is more than a second critical value,
and wherein the normalizing is performed before the step of predicting the personality traits, and the total use period is calculated through a number of days between an initial feed generation day and a final feed generation day.

10. The method of claim 9, further comprising:
learning the four personality traits models by using the user behavior parameter, the friend relation characteristic parameter and the moving path characteristic parameter.

11. A recording medium readable by a computer recording a program code performing the steps comprising:
collecting personal life log in a social network;
generating a user behavior matrix by defining an object about user's behavior through analysis of the collected personal life log in a triple structure and extracting a user behavior parameter through the generated user behavior matrix;
obtaining interaction between a user and a friend by analyzing the personal life log and obtaining a friend relation characteristic parameter by using the obtained interaction;
obtaining a moving path characteristic parameter by using location information made in a feed by the user through analysis of the personal life log; and
predicting personality traits by applying the user behavior parameter, the friend relation characteristic parameter and the moving path characteristic parameter to four learned personality traits models.

12. A personality traits prediction apparatus comprising:
a collection unit configured to collect personal life log in a social network;
a characteristic parameter extracting unit configured to generate a user behavior matrix by defining an object about user's behavior through analysis of the collected personal life log in a triple structure and extract a user behavior parameter through the generated user behavior matrix;
a friend relation analyzing unit configured to obtain interaction between a user and a friend by analyzing the personal life log and obtain a friend relation characteristic parameter by using the obtained interaction;
a moving path analyzing unit configured to obtain a moving path characteristic parameter by using location information made in a feed by the user through analysis of the personal life log; and
a prediction unit configured to predict personality traits by applying the user behavior parameter, the friend relation characteristic parameter and the moving path characteristic parameter to four learned personality traits models.
